(19) United States
(12) Patent Application Publication
(10) Pub. No.: US 2003/0232547 A1
(43) Pub. Date: Dec. 18, 2003

(54) Plug-in unit for cable modem

(76) Inventors: Ron Reiss, Yigal (IL); Natan Krishner, Modrin (IL); Israel Lavie, Rash Ha'aen (IL)

Correspondence Address: RICHARD F.JAWORSKI, Cooper & Dunham LLP, 1185 Avenue of the Americas, New York, NY, 10036, US

(21) Appl. No.: 10/174,463

(22) Filed: Jun. 17, 2002

(51) Int. Cl. H01R 13/73

(52) U.S. Cl. 439/894

(57) ABSTRACT

The present invention is directed to an ‘add-on’ device for imparting voice/sound features to a standard cable modem. A proprietary communication protocol is disclosed, which allows the add-on device and the cable modem to communicate with each other in a way that mimics the behavior of an EMTA device. The add-on device has an outline that is adapted to the outline of the cable modem, and it is mechanically secured to the cable modem by utilizing the original HFC connection of the cable modem. In order to enhance the functionality of a cable modem, the cable modem is upgraded by replacing its original software package by an upgrade software package, thereby allowing logical communication between the upgraded cable modem and the add-on device, for exchanging composite data between them. The exchanged composite data allows the combination of the upgraded cable modem and the add-on device to impart to the cable modem the capability to exchange advanced-application packets, such as voice/sound/audio packets, with a remote station over the HFC cable network.

### FIELD OF THE INVENTION

The present invention relates to the field of cable modems. More particularly, the present invention relates to a plug-in unit and related method for imparting a standard cable modem new feature, thereby enhancing its functionality.

### BACKGROUND OF THE INVENTION

A cable modem is a device that handles incoming and outgoing data signals between a cable TV operator and a personal or business computer or television set, by allowing to connect a computer to a local cable TV line that provides an access to the Internet, thereby allowing the corresponding user(s) to receive relatively high-speed data via the connected computer, as well as TV programs (i.e., by the TV set). A cable modem communicates with a computer, to which it is connected, by utilizing a standard interface (known as the “Data Over Cable Service Interface Specification”—DOCSIS), which is contained within the modem, and by utilizing a standard communication method, typically a Local Area Network (LAN) connected to 10BASE-T Ethernet card contained within the computer. In most cases, cable modems are furnished as part of the cable access service, and are not purchased directly, or installed by the subscriber.

Cable modems are largely utilized in digital communications systems. Currently, there are, in principle, two types of cable modems. The first type of cable modems includes modems capable of transferring only digital data that is normally originated by a computer (such a modem is herein after referred to as standard modem). The second type of cable modems includes more advanced cable modems. Advanced modems have the capability of handling voice applications (such as telephony voice and Voice over IP—VoIP) and/or offer advanced data processing capabilities, such as security, management and QoS. Such a cable modem is hereinafter referred to as an “advanced modem”.

Accordingly, if a user has a standard cable modem and he desires to utilize his cable TV line also for other types of applications (e.g., voice/sound applications), he must replace his standard cable modem with a more advanced type of cable modem, or, alternatively, connect a separate stand-alone module (i.e., an ‘extension’) to his cable modem. In both cases, the added cost to the user, or business, is substantial.

Conventional solutions for adding voice/sound capabilities are the Embedded MTA (EMTA) and the Stand-alone MTA (S-MTA), a notion of which is described in FIG. 1C (prior art). In FIG. 1C, cable modem 109 is connected to Cable Modem Termination System (CMTS) 101, and is capable of handling only data information. EMTA 120 is a device capable of handling also voice/sound applications, since it includes MTA 120/2 in addition to cable modem 120/1. CM 120/1 and MTA 120/2 share common resources, for example one microprocessor (not shown) that performs both the MTA and the cable modem tasks. In addition, they share a common database (not shown), which is utilized for storing files and information related to the configuration of the EMTA, Quality of Service (QoS), security, etc. A variance of EMTA 120 is the S-MTA, which comprises CM 109/1 and MTA 121. The S-MTA variance utilizes the RSVP protocol for managing the QoS of real time data. However, the latter variance is not yet technically accepted as standard, and as such, suffers from poor management of real time data quakity of service.

For handling advanced data features (such as network security, common resources allocation, remote device management and troubleshooting), a conventional solution would be to either add an external residential gateway device, or replace the existing standard modem with an advanced one. As with the EMTA/S-MTA solutions above, such a solution will be more expensive, or will lack the advantages of using common resources for features like QoS and management.

All of the methods/devices described above have not yet provided satisfactory ways for operating a conventional cable modems as in the S-MTA variance, while enjoying the benefits of the EMTA version.

It is an object of the present invention to provide a plug-in unit, or ‘add-on device’, for allowing the utilization of a standard cable modem for voice and advanced data applications.

It is another object of the present invention to provide a plug-in unit, which will allow, after being combined with a corresponding data-oriented cable modem, bi-directional voice/audio communications.

It is still another object of the present invention to provide a plug-in unit, which will allow, after being combined with a corresponding data-oriented cable modem, bi-directional communications between IP-based voice/audio devices.

It is yet another object of the present invention to provide a plug-in unit for enhancing the functionality of a data-oriented modem, which could be easily and conveniently installed on the data-oriented cable modem, i.e., without requiring any prior technical expertise.

### SUMMARY OF THE INVENTION

The present invention is directed to a plug-in unit (i.e., ‘add-on’ device) and related method, for imparting new features to a standard cable modem, thereby enhancing its functionality.

The present invention is characterized by the mechanical coupling of the add-on device onto a cable modem. i.e., the add-on device, the outline of which is adapted to the outline of the cable modem, is mechanically secured to the cable modem by utilizing the original HFC input/output connection of the cable modem. The present invention is also characterized by a proprietary communication protocol, which allows the add-on device and the cable modem, onto which the add-on device is coupled, to communicate with each other, in a way that mimics the behavior of an EMTA device. The present invention is also characterized by obtaining the advantages of embedded devices (e.g. EMTA and ERGW—Embedded Residential Gateway), such as those associated with Quality of Service (QoS), while utilizing a standard cable modem.

According to the present invention, an ‘add-on’ device is provided, for upgrading a standard cable modem. Upgradiug of the standard cable modem includes also the upgrade of the cable modem software package, by loading into the standard cable modem a new binary software image in order to allow logical communication between the upgraded cable modem and the add-on device. The upgraded cable modem comprises at least one cable TV port (e.g., an HFC port), a DC supply input and at least one regular data port, and is capable of allowing computerized system to exchange data packets with a remote station over HFC cable network through the cable TV port and data ports, by adding to the upgraded cable modem the capability of allowing a digital telephone system to exchange advanced-application packets, such as voice packets, with a remote station over the HFC cable network.

The new software package, which is uploaded into the cable modem, contains two parts. The first part includes modules for performing the (original) tasks of the standard cable modem, and the second part is responsible for bi-directional communication with the add-on device. Whenever an add-on device is connected to an upgraded cable modem, the upgraded cable modem communicates with the add-on device, in order to determine the type, or version, of the add-on device, and, thereby, to determine whether a cooperation between the cable modem and add-on device is possible.

Preferably, the new software package is uploaded into the cable modem by a cable-TV service provider, via the cable network, and the uploading process is carried out at the most convenient time, i.e., at a time that is less occupied by the user, i.e., at night, so as minimize interference to the user. Uploading the software package is carried out automatically, and the user is not involved in the process.

There are two possible Provisioning processes, associated with a ‘switching on’ process of a re-configured cable modem. The actual Provisioning process depends on whether an add-on device is connected to the upgraded cable modem. If the upgraded cable modem is not connected to an add-on device, the upgraded cable modem will undergo a normal cable modem related Provisioning process. Otherwise, the upgraded cable modem will undergo an EMTA-related Provisioning process.

The add-on device includes modules that are basically similar to modules residing in EMTA, in order to comply with the MTA Software Architecture, a Bridge and a Dispatcher, for communication with the Bridge and Dispatcher, respectively, residing in the upgraded cable modem.

The method disclosed by the present invention allows upgrading a cable modem that has at least one HF port, a DC supply input and at least one regular data port, and that is capable of allowing a computerized system to exchange regular data packets with a remote station over an HF cable network through the HF port and data ports, by adding, to the cable modem, the capability of allowing an external system, such as a telephone system, to exchange additional types of data packets/signals with a remote station, over the HF cable network.

Preferably, the method comprises:

a) providing an add-on device that has a DC supply input and at least a first and a second data ports, and one or more ports of additional types of data (e.g., voice/sound ports). The add-on device is capable of modifying the control software of, and exchanging composite data with, the cable modem through the first data port. The composite data may include, but is not limited to, data packets, voice/sound packets, other types of packets, commands, requests and messages. The add-on device is also capable of extracting/adding regular data packets and additional types of data packets/signals from/to the composite data, of exchanging additional types of data with an external system through the one, or more, ports of additional types of digital/analog signals, and of exchanging regular data packets with the computerized system through the second data port;

b) connecting the first data port to the regular data port;

c) connecting each DC input to a power supply;

d) allowing the add-on device to exchange composite data, consisting of a combination of the regular data and the additional types of data packets, with the cable modem;

e) optionally, modifying the control software of the cable modem, so as to allow the cable modem to identify additional types of data packets/signals, and to process any identified type of data packet with different priority than any data packet;

f) in the cable modem, activating classifying capability and processing additional types of data packets/signals with different priority;

g) in the add-on device:

g.1) extracting regular data packets and additional types of data packets/signals from, and/or adding regular data packets and additional types of data packets/signals to, the composite data, and processing additional types of data packets/signals with different priority; and

g.2) exchanging regular data packets with the computerized system at least through the second data port; and

g.3) exchanging additional types or regular data packets/signals with the external system through the one or more ports of additional types of data.

The present invention is characterized by its capability to modify the control software and to allow exchange of the composite data, by utilizing unique protocol, which has also the capability to determine different priority levels to different types of data packets and/or voice/sound packets.

The add-on device further comprises a DC feeding connector which mates the DC port of the cable modem, through which DC power is fed from the add-on device to the cable modem upon connecting between them. The add-on device has essentially similar outline to the outline of the cable modem, thereby increasing the physical size of the cable modem, upon connecting the add-on device to the cable modem, only along a single dimension (i.e., axis).

Upon connecting the add-on device to the cable modem, the HF cable is directly connected to the cable modem through an orifice or a slit in the housing of the add-on device. The external system may be a wired system, wireless system, wired telephonic system, wireless telephonic system, or, a combination thereof, and the data port and/or at least one of the ports of additional types of data may be a wireless port.

Preferably, the additional types of data packets/signals are selected from the group of: voice packets, data packets. The method disclosed in the present invention also includes a Provisioning stage, which is automatically performed in the cable modem and/or in the add-on device, upon connecting the first data port to the regular data port and connecting each DC input to a power supply.

The modified control software of the cable modem allows controlling the priority of processing additional types of data packets/signals according to a desired Quality of Service (QoS) for each type. The composite data, which is exchanged between the add-on device and the cable modem, further comprises obtaining operational features from the cable modem, which are selected from, but not limited to, the group of:

control commands;

bandwidth allocation for a desired QoS;

security levels for different types of data packets.

The add-on device may carry out the functionalities of a residential gateway. Preferably, the add-on device and/or the cable modem operate according to one of the following standards for cable modem interface specifications:

DOCSIS 1.0;

DOCSIS 1.1; or

DOCSIS 2.0.

The present invention also includes an add-on device for upgrading a cable modem, which has at least one HF port, a DC supply input and at least one regular data port, and that is capable of allowing a computerized system to exchange regular data packets with a remote station over an HF cable network through the HF port and data ports, by adding, to the cable modem, the capability of allowing an external system to exchange additional types of data packets/signals with a remote station over the HF cable network.

Preferably, the add-on device comprises:

a) a DC supply input and at least a first and a second data port and one or more ports of additional types of data;

b) circuitry for modifying the control software of, and exchanging composite data with, the cable modem through the first data port, for extracting/adding regular data packets and additional types of data packets/signals from/to the composite data, for exchanging additional types of data packets/signals with an external system through the one or more ports of additional types of data, and for exchanging regular data packets with the computerized system through the second data port;

c) a connector for connecting the first data port to the regular data port;

d) a DC connector for connecting the DC input to a power supply;

e) a processor for processing regular data packets and additional types of data packets;

f) software for modifying the control software of the cable modem to activate identification capability of additional types of data packets/signals and to process any identified additional types of data packet with different priority than any data packet;

g) circuitry for classifying regular data packets and additional types of data packets/signals from, and/or adding regular data packets and additional types of data packets/signals to, the composite data and processing additional types of data packets/signals with different priority;

h) circuitry for exchanging regular data packets with the computerized system through the second data port; and

i) circuitry for exchanging voice packets with an external system through the one or more ports of additional types of data.

The modification of the control software and/or the exchange of the composite data are performed using a unique protocol, which may determine different priority to additional types of data packets/signals.

The add-on device may further comprises a DC feeding connector which mates the DC port of the cable modem, through which DC power is fed from the add-on device to the cable modem upon connecting between them.

The outline of the add-on device is essentiIy similar to the outline of the cable modem. The add-on device includes an orifice or a slit in its housing, for allowing the HF cable to be directly connected to the cable modem through the housing upon connecting the device to the cable modem.

The add-on device may be connected to an external wired system, wireless system, wired telephonic system or wireless telephonic system, or to a combination thereof. The data port and/or at least one of the ports of additional types of data may be a wireless port.

The additional types of data packets/signals may be selected from the group of: voice packets; data packets. The data port and/or at least one of the ports of additional types of data may be a wireless port.

The Provisioning process is automatically performed in the cable modem and/or in the add-on device, upon connecting the first data port to the regular data port and connecting each DC input to a power supply. The modification of the control software of the cable modem allows controlling the priority of processing additional types of data packets/signals according to a desired Quality of Service (QoS) for each type.

The composite data, exchange between the add-on device and the cable modem, further comprises obtaining operational features from the cable modem, which may be selected from the group:

control commands;

bandwidth allocation for a desired QoS;

security levels for different types of data packets.

The add-on device may carry out the functionalities of a residential gateway.

The add-on device may operate according to one of the following standards for cable modem interface specifications:

DOCSIS 1.0;

DOCSIS 1.1; or

DOCSIS 2.0.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1A (prior art) illustrates a typical utilization of a standard data-oriented Cable Modem (CM) in an exemplary TV cable system;

FIG. 1B (prior art) shows a typical cable modem;

FIG. 1C (prior art) schematically illustrates a standard cable modem operating with and without a MTA;

FIG. 2 schematically illustrates the general logic aspects of the present invention;

FIGS. 3A and 3B show the respective front and rear view of the add-on device (i.e., ‘Cable Modem eXtension’—CMX), according to one embodiment of the present invention;

FIG. 4 schematically illustrates the general aspects of the present invention;

FIG. 5A is a 3-dimension general view showing a combination of cable modem and an add-on device, according to one embodiment of the present invention;

FIG. 6B illustrates securing an add-on device to a cable modem, according to a preferred embodiment of the present invention; and

FIG. 6 illustrates a 3-dimension wireless version of the add-on device (CMX 201) shown in FIGS. 3A and 3B.

### DETAILED DESCRIPTION OF PREFERRED EMBODIMENTS

The present invention utilizes some of the (known) communications techniques/protocols, the descriptions of which are given hereinafter.

MTA-—The MTA (Multimedia Terminal Adapter) contains the interface to a physical voice device(s), a network interface, CODECs, and all signaling and encapsulation functions required for ‘Voice over IP’ (VoIP) transport, CLASS features signaling, and QoS signaling.

RSVP—The RSVP (Resource Reservation Protocol) is a set of communication rules that allows channels or paths on the Internet to be reserved for the multicast (one source to many receivers) transmission of video and other high-bandwidth messages. RSVP is part of the Internet Integrated Service (IIS) model, which ensures best-effort service, real-time service, and controlled link-sharing.

The basic routing philosophy on the Internet is “best effort”, which serves most users well enough but isn't adequate for the continuous stream transmission required for video and audio programs over the Internet. With RSVP, people who want to receive a particular Internet “program” (think of a television program broadcast over the Internet) can reserve bandwidth through the Internet in advance of the program and be able to receive it at a higher data rate and in a more dependable data flow than usual. When the program starts, it will be multicast to those specific users who have reserved routing priority in advance. RSVP also supports unicast (one source to one destination) and multi-source to one-destination transmissions.

A hub is the interchange point between the regional fiber network and the cable plant. At the hub, the cable modem termination system (CMTS) coverts data from a wide area network (WAN) protocol, such as POS, into digital signals that are modulated for transmission over HFC plant, and then demodulated by the cable modem in the home or business. The CMTS unit provides a dedicated 27 Mbps downstream data channel that is shared by the 500 to 1,000 homes served by a fiber node, or group of nodes. Upstream bandwidth per node typically ranges from 2 Mbps to 10 Mbps.

HFC network—A HFC (Hybrid Fiber Coaxial) network is a telecommunication technology in which optical fiber cable and coaxial cable are used in different portions of a network to carry broadband content (such as video, data, and voice). Using HFC, a local CATV company installs fiber optic cable from the cable head-end (distribution center) to serving nodes located close to business and residential users and from these nodes uses coaxial cable to individual businesses and homes. An advantage of HFC is that some of the characteristics of fiber optic cable (high bandwidth and low noise and interference susceptibility) can be brought close to the user without having to replace the existing coaxial cable that is installed all the way to the home and business.

By using the term HF (High-Frequency), it is meant to include high-frequency analog signal that is used to carry information, whether analog or digital, by modulating the high-frequency analog signal.

“Provisioning”—In general, this term is associated with a protocol that satisfies the requirements and limitations, according to which a registrar is allowed to access multiple registries. The protocol allows interaction between a registrar's own application and registry applications. The specification should be flexible enough to support the different operational models of registries, and should allow extension to support other registration data, such as address allocation and contact information. The protocol specifies, among other things, the objects exchanged between the registry repository and registrars, the relationships among the objects, and the protocol for exchanging objects between a registrar and the registry. The objects will include at least a domain name, IP address, and contact details for registrants. The protocol also employs appropriate security mechanisms during registrar access.

In particular, Provisioning is a subset of configuration management control. The Provisioning aspects include, but are not limited to, defining configurable data attributes, managing defined attribute values, resource Initialization & Registration, managing resource software, and configuration data reporting. The resource (also referred to as the ‘managed resource’) always refers to the Multimedia Terminal Adapter MTA) devices. Further, an associated subscriber is also referred to as a managed resource.

DHCP—The DHCP (Dynamic Host Configuration Protocol) is a communications protocol that lets a network administrator manage centrally and automate the assignment of Internet Protocol (IP) addresses in an organization's network. Each machine, or computer, that is connected to the Internet needs a unique IP address. Without DHCP, the IP address must be entered manually at each computer and, if computers move to another location in another part of the network, a new IP address must be entered. DHCP allows a network administrator to supervise and distribute IP addresses from a central point and to automatically send a new IP address when a computer is plugged into a different place in the network.

TFTP—The TFTP (Trivial File Transfer Protocol is an Internet software utility for transferring files, which is simpler to use than the File Transfer Protocol (FTP) but less capable. It is used where user authentication and directory visibility are not required. TFTP uses the User Datagram Protocol (UDP) rather than the Transmission Control Protocol (TCP).

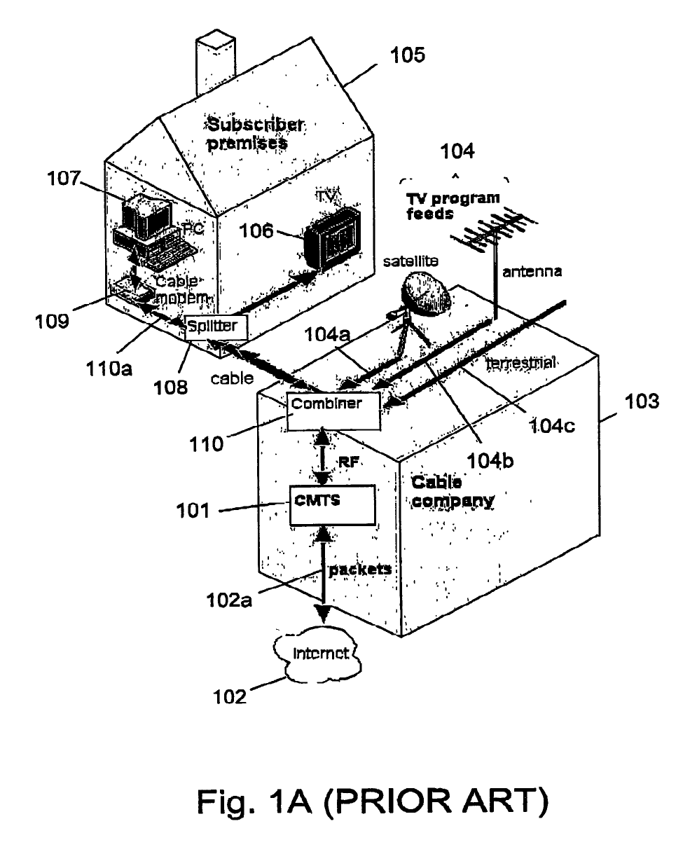

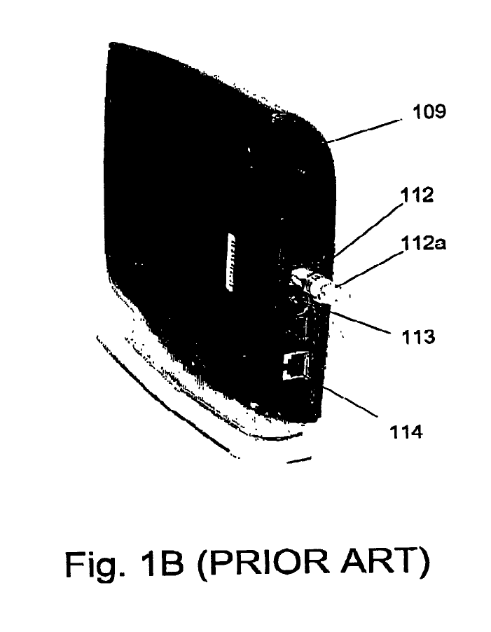

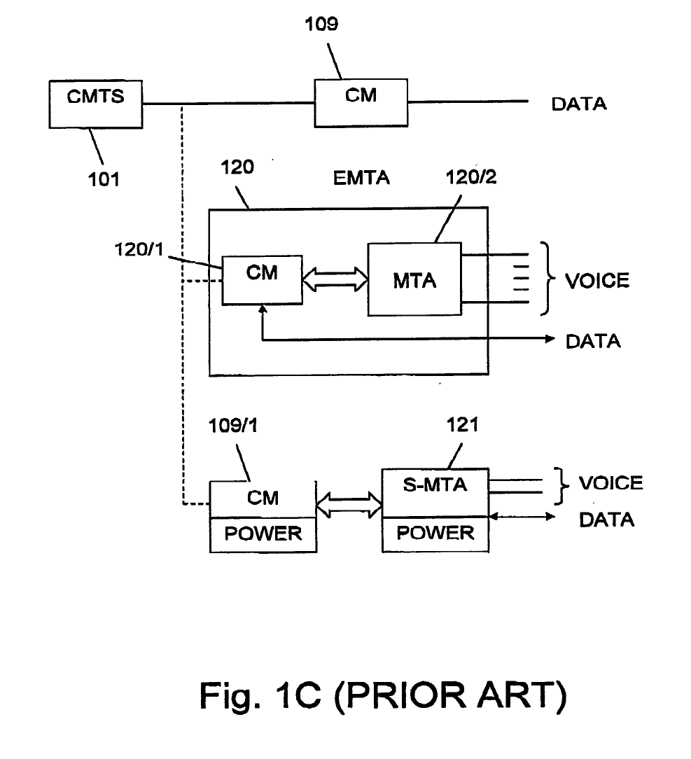

FIG. 1A (prior art) illustrates a typical utilization of a standard data-oriented Cable Modem (CM) in an exemplary TV cable system. Cable company 103 may receive TV programs from several sources; generally indicated by reference numeral 104, some of which may be forwarded to TV set 106, in subscriber premises 105, on which they become visible to the subscriber (not shown). In addition, the cable company (108) may allow the forwarding of the data packets from the Internet (102) to user's PC 107, by utilizing Cable Modem Transmission System (CMTS) 101, combiner 110, splitter 108 and cable modem 109.

Cable modem 109 accepts combined signal 110a, which includes data packets 102a, arriving from Internet 102, and TV programs 104a to 104c. However, cable modem 109 is capable of extracting, from the combined signal (110a), only data packets that am associated with applications run by user's computer 107.

It would be advantageous to allow a subscriber to utilize same cable modem (109) for voice applications, whereby a telephone (not shown) is connected to modem 109. Such voice applications may include, for example, radio-telephone systems, which use receiving means such as those indicated by reference numeral 104. Another example is utilizing the Internet for Voice over IP (VoIP) applications.

FIG. 1B (prior art) illustrates a typical data-oriented cable modem. Cable modem 111 includes RF connector 112, for accepting the combined signal 110a (see FIG. 1A), DC jack 113, for supplying the DC voltage required to operate cable modem 109, and RJ45 jack 114, being utilized as 10BASE-T connector, for allowing exchanging data with e.g., computer 104 (FIG. 1A). Cable modem 109 is not capable of handling voice applications, and, therefore, it does not include a voice socket/plug for connecting to, e.g., a telephone device.

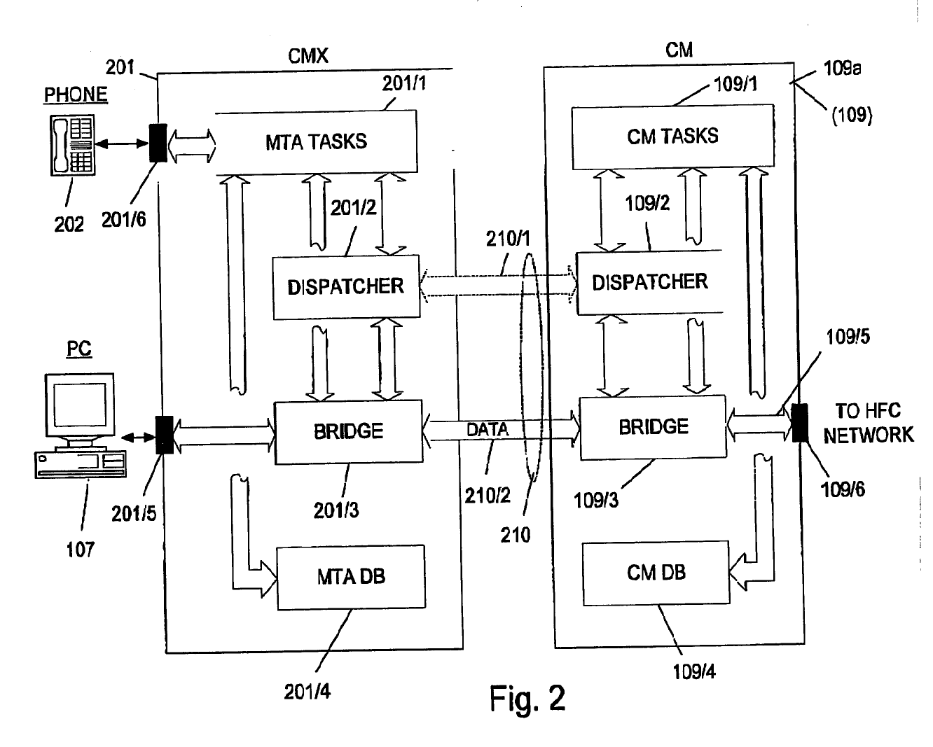

FIG. 2 illustrates the general logic aspects of the present invention. There are two types of forwarded data packets that are associated with the combined operation of CM 109a and CMX 201:

1) CMTS (not shown) data packets, which are transferred from Bridge 109/3 to the CMTS, and vice versa, via cable TV channel 109/5. This type of data packets includes:

i. CM specific packets, being associated with the provisioning stage of CM 109a, and CM 109a management services, which are carried out by employing the SNMP protocol.

ii. MTA specific packets, which are associated with the MTA provisioning, MTA SNMP management, MTA call setup signaling services and voice media, or other advanced, packets. All of the latter MTA-related tasks are carried out in CMX 201.

iii. Personal Computer (PC) data packets, which are forwarded from the Internet and intended to the PC.

The CM data packets are forwarded from Bridge 109/3 to CM TASKS 109/1, in order to impart CM 109a features of a standard cable modem. The MTA data packets are forwarded from Bridge 109/3 to MTA TASKS 201/1 via Bridge 201/3, in order to impart CMX 201 features of MTA. The PC data is forwarded from Bridge 109/3 to PC 107 (for example), via Bridge 201/3.

2) Data packets exchanged between Dispatcher 109/2 and Dispatcher 201/2. Dispatchers 109/2 and 201/2 are software interface entities that communicate with each other by utilizing a proprietary protocol that allows CM 109a and CMX 201 to emulate the EMTA behavior, by exchanging corresponding messages. More specifically, CM 109a introduces itself to CMX 201, by sending corresponding messages to CMX 201, and, likewise, CMX 201 introduces itself to 109a, by sending corresponding messages to 109a. In addition, dispatchers 109a and 201/2, and the proprietary protocol, handle for CM 109a the guaranteed rate bandwidth allocation for real-time sensitive applications, such as MTA VoIP telephony data.

In order to support the plug-in unit (CMX) functionality, the standard cable modem is upgraded by uploading into it a new software package, after which the standard cable modem becomes the upgraded cable modem 109a. Upgrading the software of the standard cable modem involves downloading to the standard cable modem, by a service provider and via the HFC channel 109/5, only one file (herein after referred to as the “upgrading file”). The upgrading file includes two portions. The first portion (i.e., CM TASKS 109/1) is intended to be utilized by cable modem (CM) 109a, and the second portion (i.e., MTA TASKS 201/1) is intended to be utilized by CMX 201. After completing the downloading of the new software package (i.e., into the standard cable modem), the corresponding CM 109a forwards the second portion to CMX 201. Alternatively, the second portion may be uploaded into CMX 201 before connecting it to CM 109a.

The first software portion (residing in CM 109a) contains two main applications. The first application handles regular tasks of CM 109a namely; it allows CM 109a to operate as a standard cable modem. The second application handles the bi-directional communication with CMX 201. CMX 201 comprises MTA TASKS 201/I, the software architecture of which resembles to the software architecture of a common standard MTA Software Architecture, in order to allow CMX 201 to manage the MTA aspects of the combination of CM 109a and CMX 201, essentially in the way a standard EMTA does. CM DB 201/4 is a database, which is utilized by CMX 201 for storing at least files, configuration and provisioning information, etc., which are required for proper functioning of CMX 201.

The relative priority of data packets (destined to PC 107, and/or to Telephone 202) is managed by CMX 201, according to the determined QoS policy, which is controlled by the CMX TASKS 109/1 and MTA TASKS 201/1.

Whenever the software package is to be upgraded, the software portion of the CM 109a and the software portion of CMX 201 are combined in one image file, which is then downloaded at the service provider request to CM 109a. CM 109a stores the portion of CMX 201 in a RAM residing within CM 109a. Upon connection of CMX 201 to CM 109a, CMX 201 forwards to CM 109a a request, indicating to CM 109a that CMX 201 requires its software portion (i.e., CMX 201's portion). Upon receiving the request from CMX 201, CM 109a utilizes the FTP/TFTP communication protocol to transfer the CMX 201's portion to CMX 201, after which a ‘successful transfer’ flag is set to “ON”. If CM 109a undergoes a “reset” condition while the its own software portion is stored (i.e., in CM 109a), but before completing the transfer of the CMX 201's portion to CMX 201, CM 109 will download again the new image file from the FTP/TFTP sever and forward the corresponding portion to the CMX 201 extension.

### Device Provisioning_

The Provisioning process of CM 109a and CMX 201 is a process, whereby these devices receive the configuration data required to provide the services programmed by the service provider. This configuration data includes IP addresses, in order to allow IP connectivity, and quality of service, security and other service related parameters.

The standard CM provisioning sequence is different from the provisioning sequence of a cable modem that supports also voice/sound applications (e.g., EMTA).

In order to mimic the Provisioning process of an EMTA device:

1) CM 109a has to identify the existence of CMX 201, after which;

2) CM 109a and CMX 201 have to exchange special handshake information during the provisioning process, and to synchronize their provisioning processes.

The latter two requirements are handled using the proprietary protocol over IP, between CM109a and CMX 201, that utilizes the physical CM to CMX data connection and the ‘virtual’ connection between Dispatchers 109/2 and 201/2 respectively, which is implemented by communication between Bridge 109/3 and Bridge 201/3.

### Managing the Quality of Service (QoS)

The QoS is managed according to the Service Level Agreement (SLA) between the TV network service provider and the end user. Accordingly, a corresponding configuration file is loaded by the service provider to CM 109a, which includes the number and types of ‘service flows’ to which the user (i.e., which operates Telephone 202 and PC 107) is entitled. Each service flow is associated with a different QoS service, and the number of service flows is identical to the number of the end-devices used by the user. Referring to FIG. 2, there are only two (exemplary) end-devices; namely Telephone 202 and PC 107.

Packets of PC 202 are managed by a CM “best effort” (i.e. with low priority) service flow. In contradiction, telephony media (voice) packets have to be managed by a service flow with guaranteed QoS parameters that are required for real time voice traffic, and that have been agreed-upon with the service provider. In order to obtain the guaranteed QoS parameters, whenever a voice call is commenced, a session is commenced, which starts by issuing, by MTA TASKS 202/1, special request, for use of such a service flow. The latter request is forwarded to CM TASKS 109/1 by using Dispatcher 201/2 to Dispatcher 109/2 peer-to-peer protocol. At the end of the voice call, the latter session ends when MTA TASKS 201/1 issues a similar request, which is forwarded to CM TASKS 109/1. The latter request causes CM TASKS 109/1 to cancel the corresponding service flow and to reserve the HFC bandwidth for other purposes, such as the best effort transfer of Internet data packets.

The management of the CMX device, from the service provider Element Management System/Network Management System (EMS/NMS), is carried out using SNMPv3 in a way which is transparent to this CM/CMX (i.e., CM 109a and CMX 201) architecture. The EMS/NMS system is dealing with the CM/CMX entity entirely in the same way it deals with any other EMTA device.

The communication between CM 109a and CMX 201 is characterized by:

1) being generic—new features may be easily added by uploading new software elements by service provider, via the HFC network;

2) allowing transmission of messages with different lengths;

3) protecting its type and version;

4) securing data/information that is exchanged via the communication channel; and

5) using a reliable transmission mechanism.

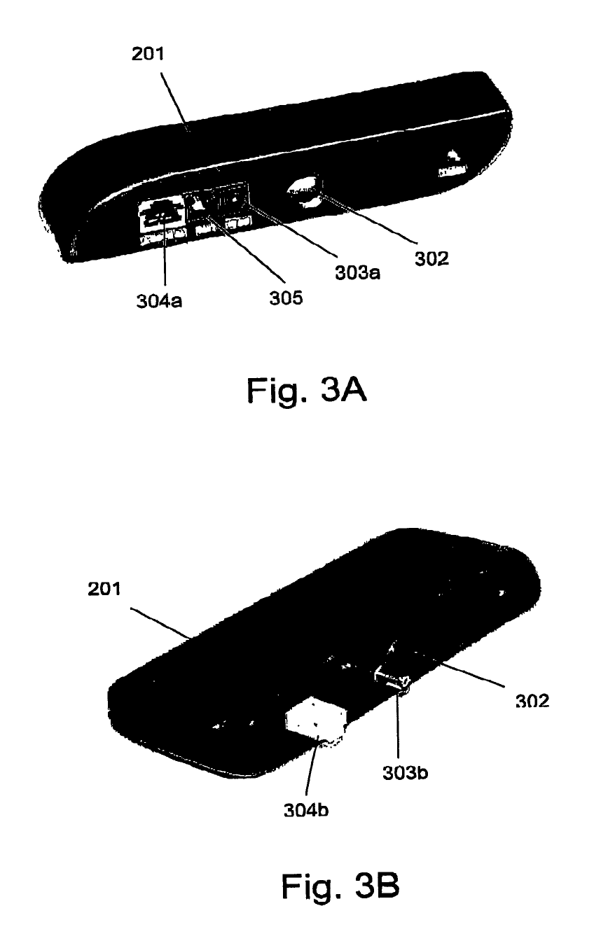

FIGS. 3A and 3B show the respective front and rear view of the add-on (Cable Modem extension), according to the preferred embodiment of the present invention. Plug-in unit 201 includes an orifice 302, through which RF connector 112, extended by corresponding RF extension connector 112a (FIG. 1B), is inserted, for allowing to conveniently connect connector 112a to an RF signal source such as splitter 108 (FIG. 1A). DC plug 303a allows connecting a DC power supply to cable modem 109 (FIG. 1B), by connecting its other end (FIG. 3B, reference numeral 303b) to DC jack 113 (FIG. 1B). DC plug 303a is utilized also for powering the electronic circuitry contained within add-on device 201. Jack 304a is connected, e.g., to user's computer 107 (FIG. 1A), while its other end (FIG. 3B, reference numeral 304b) is connected to 10BASE-T connector 114 (FIG. 1B). Socket 305 may be connected to a voice-producing device, such as telephone 202 (FIG. 2).

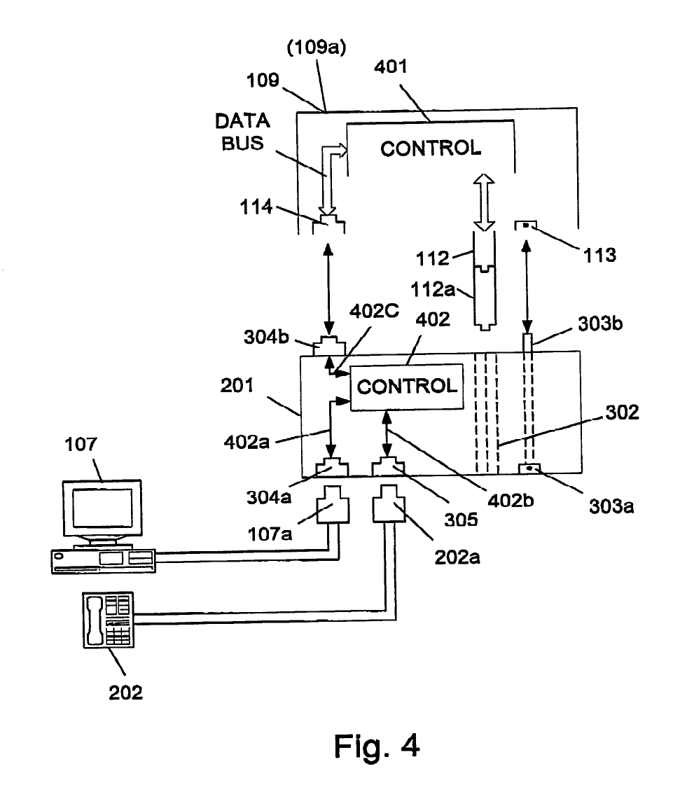

FIG. 4 schematically illustrates the general mechanical aspects of the present invention. Reference numeral 109 denotes a cable modem, which does not include a software package that is required, according to the present invention, to allow communication with add-on device 201. Reference numeral 109a denotes a standard cable modem that was upgraded; that includes a software package required for allowing communication with add-on device 201. The latter cable modem is hereinafter referred to as an “upgraded cable modem. CM 109 includes control means 401, which is responsible for the bidirectional paths of data and RF signal, i.e., via data connector 114 and RF connector 112, respectively. Control means 401 is not capable, in standard cable modem (CM) 109, of handling voice/audio applications, and therefore, CM 109 does not include a voice/audio interface. Control means 401 signifies all of the modules required for the functioning of CM 109, for example, HFC and Ethernet interfaces (i.e., to the CMTS and LAN network, respectively), memory modules, modulation/demodulation circuits, filtering circuits, Digital Signal Processing (DSP), etc.

In cases where only CM 109 is utilized (i.e., CMX 201 is not connected to CM 109), a modulated RF signal (not shown), which may include information regarding data (i.e., intended for e.g., computer 107, and/or for a LAN network, not shown) and voice/audio, is forwarded to RF connector 112. However, voice/sound portions, which may be included within the modulated RF signal, are handled transparently, since control 401 is configured to ignore voice/sound packets. Consequently, only data packets may be forwarded, e.g., to socket 114.

CMX (201) is characterized by having a control means (402), being capable, together with CM 109a (i.e., the upgraded CM 109), of handling voice/audio applications, as well as data applications. Accordingly, CMX 201 includes, in addition to data sockets 304a/b, voice/audio socket 305, to which IP-based telephone 202 (for example) could be connected.

Of course, CMX 201, PC 107 and Telephone 202, may be adapted to comply with wireless transmissions technologies. For example, PC 107 and Telephone 202 may communicate with CMX 201 over two separate wireless communication channels, or over one common wireless communication channel, via corresponding interfaces and RF antennas. Currently, there are several wireless transmission technologies, such as the Blue-Tooth technology, which could be employed by CMX 201 to communicate with, e.g., PC 107 and Telephone 202. Bluetooth is a computing and telecommunications industry specification that describes how mobile phones, computers, and personal digital assistants (PDAs) can easily interconnect with each other and with home and business phones and computers using a short-range wireless connection.

By employing the Bluetooth technology, users of cellular phones, pagers, and personal digital assistants, such as the PalmPilot, are able to have all mobile and fixed computer devices be totally coordinated. In addition to data, the Bluetooth technology supports up to three voice channels (i.e., in each Bluetooth-based device).

Bluetooth requires that a low-cost transceiver chip be included in the corresponding device. Therefore, a transceiver chip may be included in CMX 201, PC 107 and Telephone 202, thereby providing them with wireless communication capabilities.

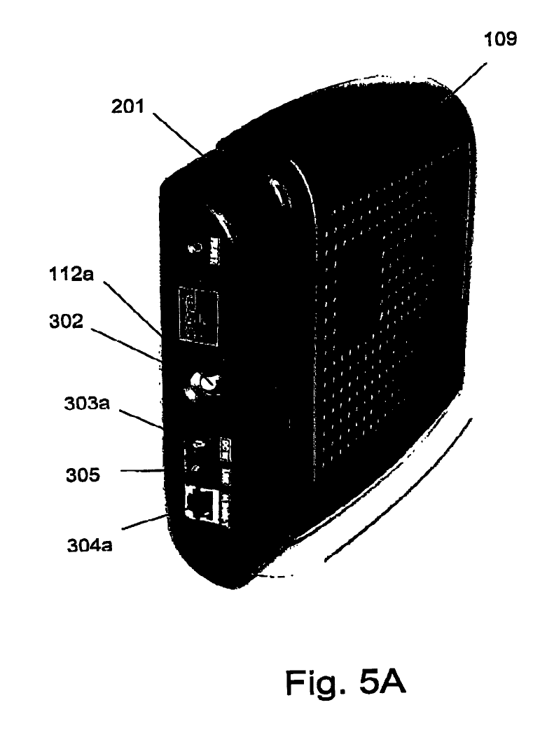

FIG. 5A is a three-dimension general view showing a combination of Cable Modem (CM) and an add-on device (CMX), according to a preferred embodiment of the present invention. CMX 201 is attached to CM 109. The functions of reference numerals 112a, 302, 303a, 304a and 305, are described above in connection with the respective Figs. In order to physically secure CMX 201 to CM 109, locking means, such as locking nut 111 (FIG. 5B), is adapted to RF extension connector 112a, which is adapted to mate a corresponding RF connector 112.

The physical outline of the plug-in unit may be easily adapted to the outline of the cable modem, with whom it is intended to work in combination. FIGS. 5A and 5B show two typical outline of both CMs and associated CMXs. The CMXs, such as shown in exemplary FIGS. 5A and 5B, are relatively small in size and can be easily installed by any person, i.e., no technical knowledge is required in order to install a CMX, or the associated devices (e.g., computer, telephone).

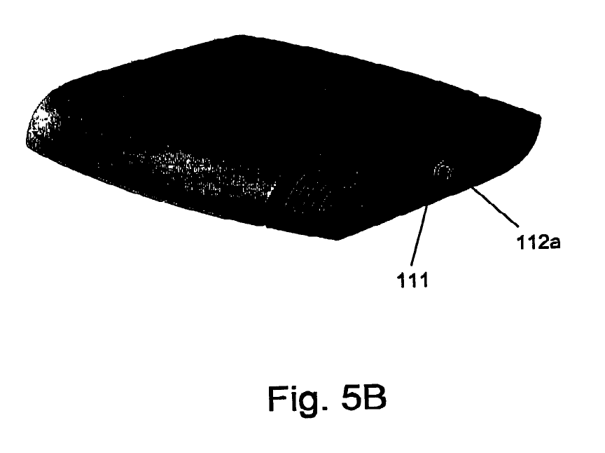

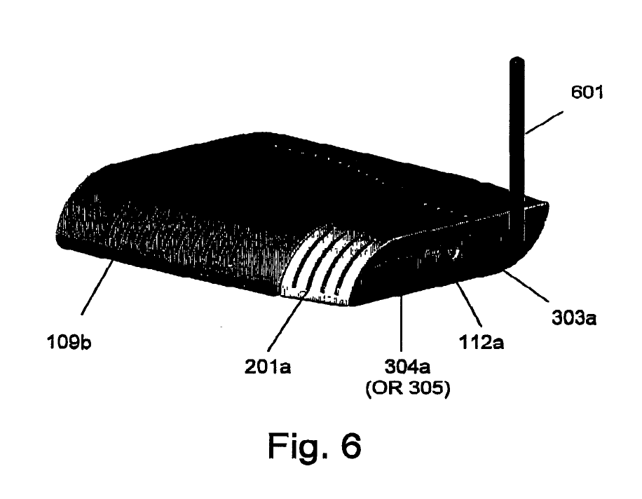

FIG. 6 shows a wireless version of the add-on device (i.e., CMX), according to another embodiment of the present invention. The functions of reference numerals 112a, 303a, 304a and 305, are described above in connection with the respective Figs. reference numeral 109b is a cable modem adapted for wireless communication technology, such as the Bluetooth. The functionality of cable modem 109b is essentially similar to the functionality of cable modem 109a, since the wireless communication is carried out between CMX 201a and the corresponding PC and/or Telephone (both not shown). Therefore, most of the tasks that are associated with the wireless communication are carried out by CMX 201a

Reference numeral 601 is an RF antenna, which may allow CMX 201a to wirelessly communicate with a nearby, e.g., Bluetooth-based, PC and Telephone devices. Alternatively, or additionally, a ‘regular’ (i.e., wired) Telephone, or PC, may be connected to input/output, which has essentially the characteristics of connector 304a or 305 (see FIG. 4).

Of course, the principles disclosed hereinabove are not limited to enhance the combination of cable modem and MTA-based devices, as these principles may be employed on other technologies, such as the technology that is generally known as the “Wireless Cable Modem Gateway” technology, and the technology that is generally known as the “Residential Gateway” technology.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A method for upgrading a cable modem having at least one HF port, a DC supply input and at least one regular data port, and being capable of allowing a computerized system to exchange regular data packets with a remote station over an HF cable network through said HF port and data ports, by adding, to said cable modem, the capability of allowing an external system to exchange additional types of data packets/signals with a remote station, over said HF cable network, comprising:
a) providing an add-on device, having a DC supply input and at least a first and a second data ports and one or more ports of additional types of data and being capable of modifying the control software of, and exchanging composite data with, said cable modem through said first data port, of extracting/adding regular data packets and additional types of data packets/signals from/to said composite data, of exchanging additional types of data with an external system through said one or more ports of additional types of digital/analog signals, and of exchanging regular data packets with said computerized system through said second data port;
b) connecting said first data port to said regular data port;
c) connecting each DC input to a power supply;
d) allowing said add-on device to exchange composite data, consisting of a combination of said regular data and said additional types of data packets, with said cable modem;
e) optionally, modifying the control software of said cable modem to identify additional types of data packets/signals and to process any identified type of data packet with different priority than any data packet;
f) in said cable modem, activating classifying capability and processing additional types of data packets/signals with different priority;
g) in said add-on device:
g.1) extracting regular data packets and additional types of data packets/signals from, and/or adding regular data packets and additional types of data packets/signals to, said composite data and processing additional types of data packets/signals with different priority; and
g.2) exchanging regular data packets with said computerized system at least through said second data port; and
g.3) exchanging additional types of regular data packets/signals with said an external system through said one or more ports of additional types of data.

2. A method according to claim 1, wherein the modification of the control software and/or the exchange of the composite data are performed using a unique protocol determining different priority levels to different types of data packets.

3. A method according to claim 1, wherein the add-on device further comprises a DC feeding connector which mates the DC port of the cable modem, through which DC power is fed from said add-on device to said cable modem upon connecting between them.

4. A method according to claim 1, wherein the add-on device has essentially similar outline to the outline of the cable modem, thereby increasing the physical size of said cable modem, upon connecting said add-on device to said cable modem, only along a single dimension.

5. A method according to claim 4, wherein upon connecting said add-on device to said cable modem, the HF cable is directly connected to the cable modem through an orifice or a slit in the housing of said add-on device.

6. A method according to claim 1, wherein the external system is a wired or wireless system.

7. A method according to claim 1, wherein the external system is a wired or wireless telephonic system.

8. A method according to claim 1, wherein the additional types of data packets/signals are selected from the group:
voice packets;
data packets.

9. A method according to claim 1, wherein the data port and/or at least one of the ports of additional types of data is a wireless port.

10. A method according to claim 1, wherein a provisioning process is automatically performed in the cable modem and/or in the add-on device, upon connecting the first data port to the regular data port and connecting each DC input to a power supply.

11. A method according to claim 1, wherein the modifying the control software of the cable modem allows controlling the priority of processing additional types of data packets/signals according to a desired Quality of Service (QoS) for each type.

12. A method according to claim 1, wherein the exchange composite data between the add-on device and the cable modem further comprises obtaining operational features from said cable modem, selected from the group:
control commands;
bandwidth allocation for a desired QoS;
security levels for different types of data packets.

13. A method according to claim 1, wherein the add-on device carries out the functionalities of a residential gateway.

14. A method according to claim 1 wherein the add-on device and/or the cable modem operate according to one of the following standards for cable modem interface specifications:
DOCSIS 1.0
DOCSIS 1.1
DOCSIS 2.0

15. An add-on device for upgrading a cable modem having at least one HF port, a DC supply input and at least one regular data port, and being capable of allowing a computerized system to exchange regular data packets with a remote station over an HF cable network through said HF port and data ports, by adding, to said cable modem, the capability of allowing an external system to exchange additional types of data packets/signals with a remote station over said HF cable network, comprising:
a) a DC supply input and at least a first and a second data ports and one or more ports of additional types of data;
b) circuitry for modifying the control software of, and exchanging composite data with, said cable modem through said first data port, for extracting/adding regular data packets and additional types of data packets/signals from/to said composite data, for exchanging additional types of data packets/signals with an external system through said one or more ports of additional types of data, and for exchanging regular data packets with said computerized system through said second data port;
c) a connector for connecting said first data port to said regular data port;
d) a DC connector for connecting said DC input to a power supply;
e) a processor for processing regular data packets and additional types of data packets;
f) software for modifying the control software of said cable modem to activate identification capability of additional types of data packets/signals and to process any identified additional types of data packet with different priority than any data packet;
g) circuitry for classifying regular data packets and additional types of data packets/signals from, and/or adding regular data packets and additional types of data packets/signals to, said composite data and processing additional types of data packets/signals with different priority;
h) circuitry for exchanging regular data packets with said computerized system through said second data port; and
i) circuitry for exchanging voice packets with an external system through said one or more ports of additional types of data.

16. A device according to claim 15, in which the modification of the control software and/or the exchange of the composite data are performed using a unique protocol determining different priority to additional types or data packets/signals.

17. A device according to claim 15, further comprising a DC feeding connector which mates the DC port of the cable modem, through which DC power is fed from said add-on device to said cable modem upon connecting between them.

18. A device according to claim 15, having essentially similar outline to the outline of the cable modem.

19. A device according to claim 18, having an orifice or a slit in its housing for allowing the HF cable to be directly connected to the cable modem through said housing upon connecting said device to said cable modem.

20. A device according to claim 15, connected to an external wired or wireless system.

21. A device according to claim 15, connected to a wired or wireless telephonic system.

22. A device according to claim 15, in which the additional types of data packets/signals are selected from the group:
voice packets;
data packets.

23. A device according to claim 15, in which the data port and/or at least one of the ports of additional types of data is a wireless port.

24. A device according to claim 15, in which a provisioning process is automatically performed in the cable modem and/or in the add-on device, upon connecting the first data port to the regular data port and connecting each DC input to a power supply.

25. A device according to claim 15, in which the modification of the control software of the cable modem allows controlling the priority of processing additional types of data packets/signals according to a desired Quality of Service (QoS) for each type.

26. A device according to claim 15, in which the exchange composite data between the add-on device and the cable modem further comprises obtaining operational features from said cable modem, selected from the group:
control commands;
bandwidth allocation for a desired QoS;
security levels for different types of data packets.

27. A device according to claim 15, which carries out the functionalities of a residential gateway.

28. A device according to claim 15, which operates according to one of the following standards for cable modem interface specifications:
DOCSIS 1.0
DOCSIS 1.1
DOCSIS 2.0

29. An upgraded cable modem, consisting of an add-on device, operating in combination with the cable modem, as described in claim 15 above.
